(19) United States
(12) Patent Application Publication
(10) Pub. No.: US 2007/0216646 A1
(43) Pub. Date: Sep. 20, 2007

(54) COMPUTER MOUSE WITH HEATING FUNCTION

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,768

(22) Filed: Sep. 22, 2006

(30) Foreign Application Priority Data
Mar. 15, 2006 (CN) 200610034449.5

(51) Int. Cl. G09G 5/08

(52) U.S. Cl. 345/163

(57) ABSTRACT

A mouse having a heating function is provided. The mouse includes a shell, a cable connected to a host computer for transmitting signal from the mouse to the host computer, and a heating device mounted in the shell. The heating device includes an electric heater, and a switch connected in series with the electric heater to a power source.

### FIELD OF THE INVENTION

The invention relates to an input device for use in a computer system. In particular, the present invention relates to a mouse having a heating function.

### DESCRIPTION OF RELATED ART

The internal components of a computer mouse are very simple. In view of the space required for these components, the volume of available space remaining in the mouse is comparatively great. That is because the size of the housing of the mouse is designed for being conveniently and comfortably grasped by a user, and thus most of the inside space of the mouse is vacant.

A conventional mouse includes a shell, two buttons, and optionally a scroll wheel. The shell includes an upper portion and a lower portion. The buttons and the scroll wheel are disposed at the front part of the upper portion for finger pressing, and a rear part of the upper portion is in a raised shape for comfortable contact with a palm of the user.

When the user operates the mouse under a low temperature, the user's hand may become cold and numb.

What is needed is a mouse having a heating function.

### SUMMARY OF THE INVENTION

An exemplary mouse having a heating function is provided. The mouse includes a shell, a cable connected to a host computer for transmitting signal from the mouse to the host computer, and a heating device mounted in the shell. The heating device includes an electric heater, and a switch connected in series with the electric heater to a power source.

Other advantages and novel features will become more apparent from the following detailed description when taken in conjunction with the accompanying drawing, in which:

### BRIEF DESCRIPTION OF THE DRAWINGS

FIG. 1 is a partly cut away side view of a mouse in accordance with a first preferred embodiment of the present invention;

FIG. 2 is a schematic circuit diagram of the mouse of FIG. 1;

FIG. 3 is a partly cut away side view of a mouse in accordance with a second preferred embodiment of the present invention; and

FIG. 4 is a schematic circuit diagram of the mouse of FIG. 3.

### DETAILED DESCRIPTION OF THE INVENTION

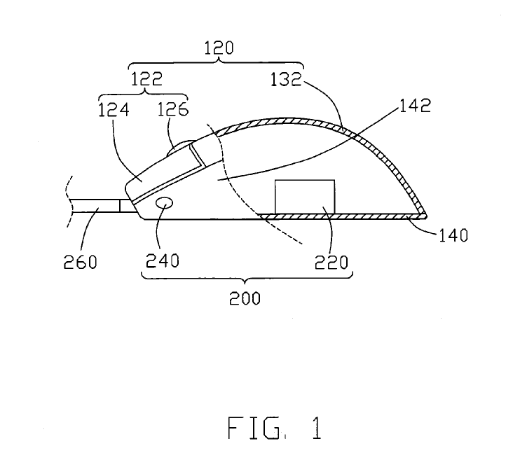

Referring to FIG. 1, a mouse in accordance with a first preferred embodiment of the present invention includes a shell, a cable 260, and a heating device 200 mounted in the shell.

The shell includes an upper portion 120 and a lower portion 140. A front part of the upper portion 120 is used as a finger operating portion 122 that includes two buttons 124 (only one is shown) and a scroll wheel 126. The buttons 124 and the scroll wheel 126 are configured for finger pressing. A rear part of the upper portion 120 has a raised palm holding portion 132. The lower portion 140 includes a sidewall 142, which is connected with the upper portion 120.

The heating device 200 includes an electric heater 220 and a switch 240. The switch 240 is placed on the sidewall 142 of the lower portion 140. The electric heater 220 is mounted in the lower portion 140 under the palm holding portion 132 of the upper portion 120. The switch 240 is used to turn the electric heater 220 on and off. The cable 260 extends out of the shell to connect with a host computer. In the preferred embodiment of the present invention, the cable 260 is a universal serial bus (USB) cable. The cable 260 is used to transmit signals of the buttons 124 and the scroll wheel 126 to the host computer and transmit power from the host computer to the electric heater 220.

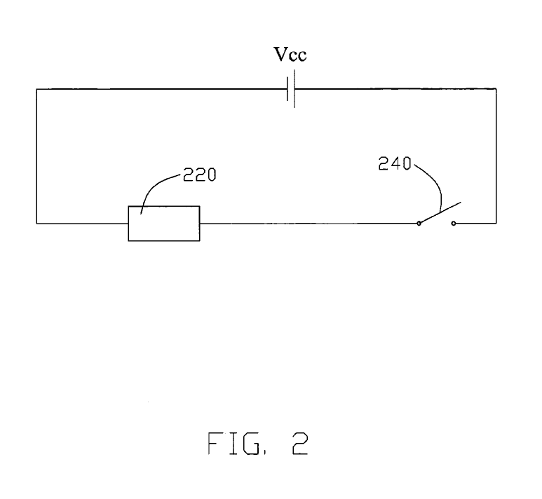

Referring also to FIG. 2, a USB power supply source Vcc in the host computer is electrically connected to the electric heater 220 and the switch 240 via the cable 260. When the switch 240 is turned on the electric heater 220 generates heat. The heat produced by the electric heater 220 is conducted to the shell warming a user's hand.

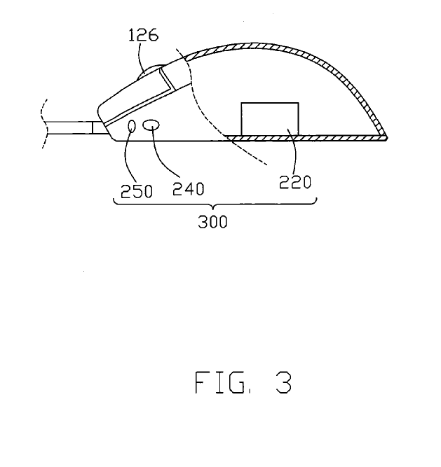

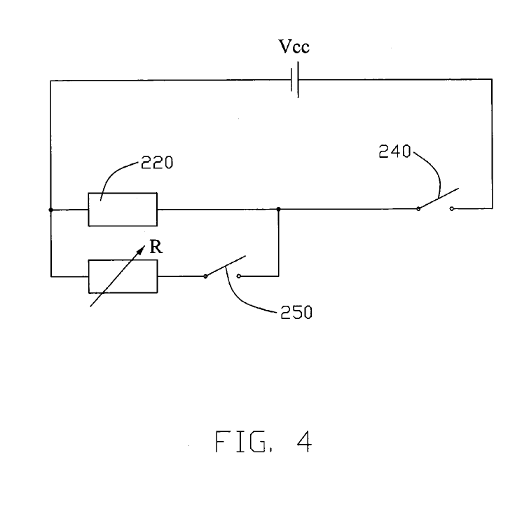

Referring also to FIGS. 3 and 4, a mouse in accordance with a second preferred embodiment of the present invention includes a heating device 300 similar to the first preferred embodiment. The heating device 300 includes the electric heater 220 and the switch 240, and further includes a scroll wheel switch 250 and a rheostat R. The scroll wheel switch 250 is placed on the sidewall 142 of the lower portion 140. The rheostat R is connected in series with the scroll wheel switch 250 and forms a branch circuit. The branch circuit is connected in parallel with the electric heater 220. The scroll wheel 126 is connected to an adjusting bar of the rheostat R. Scrolling the scroll wheel 126 moves the adjusting bar of the rheostat R to change the resistance of the rheostat R.

When the user wants to turn on the heater 220, the switch 240 is turned on and heat is generated by the electric heater 220, warming the shell to thereby warm the user's hand.

The user can adjust a temperature at the shell, by use of the scroll wheel switch 250. When the scroll wheel switch 250 is turned on the scroll wheel 126 is cut off from the host computer to prevent accidental input of the scroll wheel 126, and is capable of adjusting voltage to the electric heater 220 by changing resistance of the rheostat R, thus providing an adjustable hand held heater.

Alternatively, the electric heater 220 can also be automatically switched on or off by a software and a sensor. For example, the sensor senses temperature at a location of the mouse, and the software sends out a command in response to the sensed temperature to the electric heater 220 to open the electric heater 220. The command sent out from the software is transmitted to the electric heater 220 via the cable 260.

Otherwise, the mouse can be a wireless mouse without the cable 260, and the power source providing power to the heating device is a battery installed within the shell.

The mouse in accordance with the preferred embodiments of the present invention can increase comfort for the user by warming the user's hand. Further, used as a hand held heater, other parts of the user's body can be warmed as well.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A mouse having a heating function, the mouse comprising a shell, a cable connected to a host computer for transmitting signal from the mouse to the host computer, and a heating device mounted in the shell, the heating device comprising an electric heater and a switch connected in series between the electric heater and a power source.

2. The mouse as claimed in claim 1, wherein the shell includes an upper portion and a lower portion, a front part of the upper portion is a finger operating portion, a rear part of the upper portion is a palm holding portion.

3. The mouse as claimed in claim 1, wherein the power source is installed within the host computer, and the cable is electrically connected between the power source and the heating device.

4. The mouse as claimed in claim 2, wherein the lower portion of the shell includes a sidewall connected with the upper portion, the switch is placed on the sidewall of the lower portion.

5. A mouse having a heating function, the mouse comprising a shell having a scroll wheel, a heating device mounted in the shell, and a cable connected to a host computer, the heating device comprising an electric heater, a switch, a rheostat with an adjusting bar, and a scroll wheel switch, the switch being connected in series between the electric heater and a power source of the host computer, the cable being connected to the electric heater and the switch, the rheostat being connected in series with the scroll wheel switch to form a branch circuit which is connected in parallel with the electric heater, the scroll wheel being connected to the adjusting bar of the rheostat, and a heating power of the electric heater being adjusted by operating the scroll wheel.

6. The mouse as claimed in claim 5, wherein the cable extends out of the shell to connect with the host computer to transmit power from the host computer to the electric heater, and transmit data from the mouse to the host computer.

7. The mouse as claimed in claim 6, wherein the switch controls the electric heater to turn on and off, and when the scroll wheel switch is turned on the scroll wheel is cut off from the host computer.

8. The mouse as claimed in claim 5, wherein the shell includes an upper portion and a lower portion, a front part of the upper portion is a finger operating portion, a rear part of the upper portion is a palm holding portion.

9. The mouse as claimed in claim 8, wherein the finger operating portion includes the scroll wheel configured for finger pressing, the palm holding portion has a raised shape configured for contacting a palm of a user.

10. The mouse as claimed in claim 8, wherein the lower portion includes a sidewall connected with the upper portion, the switch and the scroll wheel switch are placed on the sidewall of the lower portion.

11. A mouse comprising:
a shell comprising an upper portion and a lower portion, the upper portion comprising a finger operating portion mounted at a front part thereof, and a palm holding portion formed at a rear part thereof,
a heating device installed in the shell and electrically coupling to a power source for generating heat to warm the shell.

12. The mouse as claimed in claim 11, further comprising a cable configured for connecting the mouse with a host computer to transmit signal between the host computer and the finger operating portion.

13. The mouse as claimed in claim 11, wherein the power source is installed within the host computer, and the cable is electrically connected between the power source and the heating device.

14. The mouse as claimed in claim 11, wherein the mouse is a wireless mouse and the power source is a battery installed within the shell.

15. The mouse as claimed in claim 11, wherein the heating device comprises an electric heater and a switch connected in series between the electric heater and the power source.

16. The mouse as claimed in claim 15, wherein the heating device further comprises a rheostat with an adjusting bar and a scroll wheel switch connecting with the rheostat in series to form a branch circuit which is connected in parallel with the electric heater, a scroll wheel being mounted to the shell and connecting with the adjusting bar of the rheostat for adjusting a resistance of the rheostat via operation of the scroll wheel.
